(19) United States
(12) Patent Application Publication
(10) Pub. No.: US 2010/0026699 A1
(43) Pub. Date: Feb. 4, 2010

(54) DISPLAY DEVICE AND ADJUSTMENT METHOD THEREFOR

(75) Inventors: Wen Cheng HUANG, Bade City (TW); Lu Hao CHEN, Taipei County (TW); Chung Ming YAO, Yunlin County (TW); Chang Chen CHIEN, Shulin City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HANNSTAR DISPLAY CORPORATION, Taipei City (TW)

(21) Appl. No.: 12/485,402

(22) Filed: Jun. 16, 2009

(30) Foreign Application Priority Data
Jul. 29, 2008 (TW) 097128702

(51) Int. Cl. G09G 5/00; G09G 3/28

(52) U.S. Cl. 345/581; 345/60

(57) ABSTRACT

An adjustment method for a display device is provided. The display device includes a screen, a button and plural display modes including at least a first display mode and a second display mode. The adjustment method comprises steps of pressing the button once to display the first display mode on the screen when the display device is on, waiting for a waiting time when the first mode is desired to be selected, pressing the button again during the waiting time to display the second display mode on the screen when the first mode is not desired to be selected, and waiting for a waiting time when the second mode is desired to be selected.

### FIELD OF THE INVENTION

The present invention relates to a display device and the adjustment method therefor, specially a liquid crystal display (LCD) device and the display mode adjustment method therefor.

### BACKGROUND OF THE INVENTION

It is frequently required to adjust the display parameters of the display device, e.g. liquid crystal display, based the using conditions. These display parameters are often too professional for the users. Accordingly the users do not know how to set up these parameters, and feel troubled.

FIG. 1 is the schematic diagram showing the conventional adjustment method for the display performance of the LCD. Please refer to FIG. 1. Firstly, the user 10 utilizes the key pad 12, which may be located in the lower portion of the television (TV) or on a remote controller. The display function key on the key pad 12 is pressed by user 10. Then, the display parameters 14 will appear on the screen to partially or completely cover the original picture displayed on the screen. For instance, the texts of the display parameters, such as brightness, contrast ratio, color temperature, horizontal position, vertical position, clock, phrase, etc., will appear on the screen. At that moment, user 10 can utilize the Up and Down buttons on the key pad 12 to move the cursor to some specific parameter, and press the Enter button to adjust that specific parameter. The bar chart or the default number will appear on the screen. The user 10 can utilize the numerical buttons on key pad 12 to enter a new set number, or press the Right or Left buttons on key pad 12 to adjust the relative magnitude of that parameter on the bar chart, and finally press the Enter button to complete the parameter setting. As to the setting of the other parameters, the same method can be followed to finish the setting of each parameter one by one and finally to complete the display function settings of the display device 16.

The above mentioned setting method is quite inconvenient. Furthermore, when the using condition is changed, the same tedious setting procedures have to be run again. For example, when reading the emails right after watching DVD, the user has to set up the display parameters again; otherwise the screen is too bright and harsh for the eyes of the user. From the above, it can be seen that it is certainly necessary to improve the setting method for the display parameters. Moreover, it can be worse that these display parameters are too professional for a lot of users, and the users do not know what the brightness, contrast ratio, color temperature are, and are troubled by completely no idea about the display parameter setting.

From the above, the conventional adjustment method of the display parameters for the display device anxiously needs to be improved. The development team of the present invention paid a lot of efforts in the research and analysis in this field, and finally developed a novel and effective adjustment method for the display devices. After several trials and improvements, the present invention can solve the above-mentioned problems by introducing the novel technical logic and the friendly operation modes, and can eventually benefit all the users. The present invention is described below.

### SUMMARY OF THE INVENTION

The present invention provides an adjustment method for the display devices without the manual setting of the complicated display parameters.

In accordance with one aspect of the present invention, an adjustment method for a display device is provided. The display device includes a screen, a button and plural display modes including at least a first display mode and a second display mode. The adjustment method comprises steps of pressing the button once to display the first display mode on the screen when the display device is on, waiting for a waiting time when the first mode is desired to be selected, pressing the button again during the waiting time to display the second display mode on the screen when the first mode is not desired to be selected, and waiting for the waiting time when the second mode is desired to be selected.

Preferably, the method further comprises a step of when the second mode is not desired to be selected, pressing the button again during the waiting time to display the first display mode if the plural display modes have only two display modes, and to display a next display mode if the plural display modes have more than two display modes.

Preferably, each of the plural display modes is one selected from a group consisting of a general mode, a text mode, a game mode, a movie mode, an X-contrast mode, an X-fine-tuning mode, an internet mode, a portrait mode, a scenery mode, a vivid mode, a sports mode and a diagram mode, and the plural display modes are different from one another.

Preferably, the method further comprises a step of pressing the button once to turn on the display device when the display device is off.

Preferably, the method further comprises a step of pressing the button for a holding time to turn off the display device when the display device is on.

In accordance with another aspect of the present invention, here a display device having plural display modes is provided. The display device comprises a button selecting a first display mode from the plural display modes, wherein the first display mode is selected by using only the button, and a screen displaying the first display mode.

Preferably, the display device is a flat panel display device.

Preferably, the flat panel display device is one selected from a group consisting of a liquid crystal display device, a plasma display device, a light emitting diode display device, an organic light emitting diode display device and a carbon nano-tube display device.

Preferably, vision, a monitor, a digital photo frame, a mobile phone and an image player.

Preferably, each of the plural display modes is one selected from a group consisting of a general mode, a text mode, a game mode, a movie mode, an X-contrast mode, an X-fine-tuning mode, an internet mode, a portrait mode, a scenery mode, a vivid mode, a sports mode and a diagram mode, and the plural display modes are different from one another.

Preferably, the button is used to turn on and to turn off the display device.

Preferably, the button is pressed once to turn on the display device when the display device is off.

Preferably, the button is pressed for a holding time to turn off the display device when the display device is on.

Preferably, the holding time is in a range of 2 to 5 seconds.

Preferably, the plural display modes comprise at least the first display mode and a second display mode, and one of the plural display modes is selected and displayed on the screen by steps of pressing the button to display the first display mode on the screen when the display device is on, waiting a waiting time when the first display mode is desired to be selected, pressing the button again during the waiting time to display the second display mode on the screen when the first mode is not desired to be selected, waiting for the waiting time when the second mode is desired to be selected, and when the second mode is not desired to be selected, pressing the button again during the waiting time to display the first display mode if the plural display modes have only two display modes, and to display a next display mode if the plural display modes have more than two display modes.

Preferably, the waiting time is in a range of 2 to 5 seconds.

Preferably, each of the display modes comprises predetermined display parameters, each of which is one selected from a group consisting of a brightness, a contrast ratio, a color temperature, a gamma value and a sharpness, and the predetermined display parameters are different from one another.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing the conventional adjustment method for the display performance of the LCD;

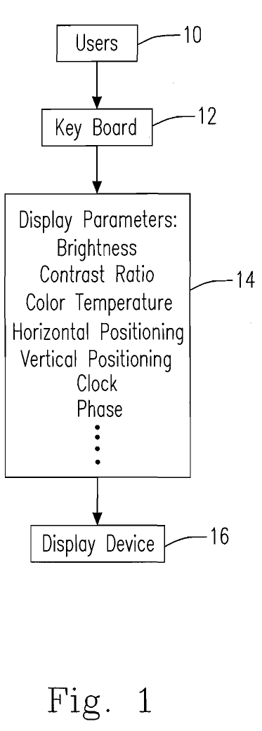

FIG. 2 is the schematic diagram showing the adjustment method of the display performance according to the first embodiment of the present invention;

FIG. 3 is the schematic diagram showing the display mode of the adjustment method of display performance according to the second embodiment of the present invention; and

FIG. 4 is the schematic diagram showing the display device according to the third embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

### First Embodiment

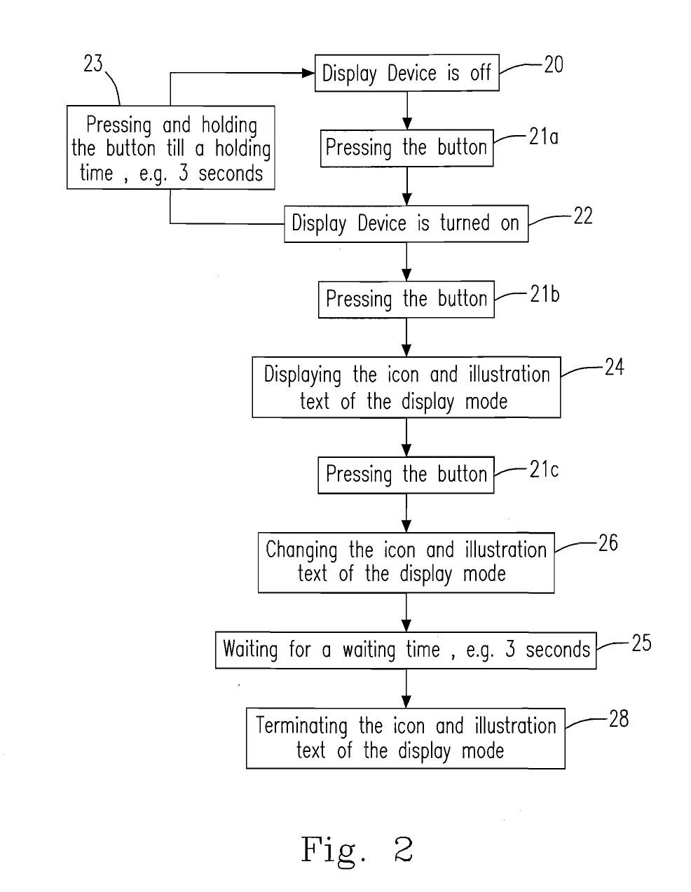

Please refer to FIG. 2, which is the schematic diagram showing the adjustment method of the display performance according to the first embodiment of the present invention. W hen the display device is closed in Step 20, the button can be pressed once in Step 21a so as to turn on the display device in Step 22. When the original button is pressed once again in Step 21b, the icon and/or illustration texts for the display mode will be shown on the screen in Step 24. For example, the text, “Text Mode”, is shown on the screen, and the picture of the screen is displayed according to the display parameters set in the “Text Mode”. When the original button is pressed once again in Step 21c, the icon and/or illustration texts of the next display mode will be shown on the screen in Step 26. For instance, the text, “Movie Mode”, is shown on the screen. Similarly, the picture on the screen is displayed according to the display parameters set in the “Movie Mode”. In Step 25, when the original button is not pressed during the waiting time (can be set to 2-5 seconds, e.g. 3 seconds, as considering the user's behaviors), the display device is designed to choose that display mode and to turn off the display of the icon and/or illustration text of that display mode in Step 28. When the original button is pressed once again during the waiting time, e.g. 3 seconds, the next display mode will be shown on the screen. When the last display mode is shown on the screen, and the original button is pressed again during the waiting time, e.g. 3 seconds, then the first display mode will be shown on the screen circulatively.

Whenever the display device is turned on, and the original button is continuously pressed and held for a holding time in Step 23 (can be set to 2-5 seconds, e.g. 3 seconds, as considering the user's behaviors), the display device can be turned off.

In this embodiment, the user can use a single button to turn on and to turn off the display device and to choose the display mode for the display device. The operations are quite easy for the users. The display mode shown on the screen is friendly and understandable, such as Text, Movie, etc. No display parameter with profound professional term, e.g. brightness, contrast ratio, color temperature, etc. needs to be set. Therefore, the easy and convenient adjustment method with the technical novelty is introduced in this embodiment, can solve the problem of the complicated display parameter settings in the current techniques, and can provide the great advantages for all the users.

Although only a single button is used in this embodiment, the display device can be designed to contain two buttons as well based on the spirit of present invention. For example, one is used as a switching button to turn on and off the display device, and the other one is used as an operation button to choose the desired display mode. This design is still within the spirit and protection scope of the present invention.

### Second Embodiment

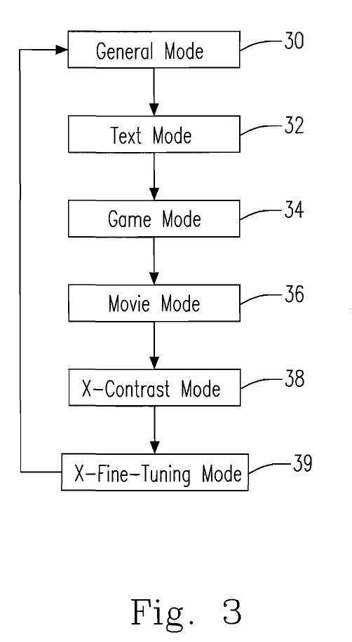

Please refer to FIG. 3, which is the schematic diagram showing the display mode of the adjustment method of display performance according to the second embodiment of the present invention. In this embodiment, there are six display modes are cited, i.e. “General Mode” 30, “Text Mode” 32, “Game Mode” 34, “Movie Mode” 36, “X-Contrast Mode” 38, and “X-Fine-Tuning Mode” 39. Similarly as the first embodiment, when the display device is on, the user can press the original button once, and then the first display mode, i.e. “General Mode” 30, will be shown in and covering the real-time picture on the screen. When the user presses the original button once again during the preset waiting time, e.g. 3 seconds, the next display mode, i.e. “Text Mode” 32, will be shown on the screen. By using the same method, when the user continuously presses the original button within the preset waiting time, e.g. 3 seconds, in each time for several times, then the following display modes, “Movie Mode” 36, “X-Contrast Mode” 38, “X-Fine-Tuning Mode” 39, and back to the first mode, “General Mode” 30, will be sequentially and circulatively displayed on the screen. Whenever the user does not press the original button during the preset waiting time, e.g. 3 seconds, the display device is designed to choose the display mode at that time, to terminate the display of the icon and/or illustration text on the screen, and to display only the real-time picture on the screen.

In this embodiment, six display modes are cited. The user can quickly and conveniently select the desired display mode according to the usage situation, and does not need to do the complicated settings for the profound display parameters. This embodiment provides the adjustment method for the display device with the easy and convenient operations suitably for the general users. If the user is an expert and is professional in the display performance setting, then the display mode, “X-Fining-Tuning Mode” 39, is available to do the customized setting for the display parameters according to the personal preferences. Therefore, the present invention can provide both the operational convenience and the professionalism for the adjustment of the display performance of the display device.

The preset display parameters of the various display modes in this embodiment are listed in the following Table 1 for the reference.

TABLE 1

| | Bright- | Contrast | Gamma | Sharp- | Color |
|---|---|---|---|---|---|
| Modes | ness | Ratio | Value | ness | Temperature |
| General | 100% | 75% | Gamma 2.2 | Level 3 | Default Value |
| Text | 20% | 75% | Gamma 1.5 | Level 6 | Default Value |
| Game | 100% | 80% | Gamma 2.2 | Level 0 | Default Value |
| Movie | 100% | 80% | Gamma 2.2 | Level 0 | 6500 K |
| X-Contrast | 100% | 75% | Gamma 1.0 | Level 3 | 6500 K |
| X-Fine- | User | User | Gamma 2.2 | User | User Setting |
| Tuning | Setting | Setting | | Setting | |

Beside the above six display modes disclosed in embodiment, more display modes can be selectively introduced as well certainly, such as internet mode, portrait mode, scenery mode, vivid mode, sports mode, diagram mode, or other specific display modes according to the spirit of the present invention.

### Third Embodiment

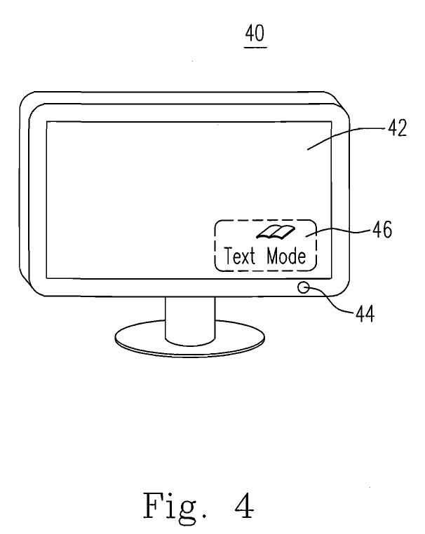

Please refer to FIG. 4, which is the schematic diagram showing the display device according to the third embodiment of the present invention. The display device 40 includes screen 42 and button 44 in this embodiment. The display device 40 can be a flat panel display, such as a liquid crystal display (LCD), a plasma display, a light emitting diode (LED) display, an organic LED display (or called organic electroluminescent display), a carbon nano-tube display, etc. Here the LCD is chosen in this embodiment just for the illustration.

When the display device 40 is turned off, pressing the button 44 once can turn on the display device 40. When the button 44 is pressed again, the icon and the illustration text 46 of the display mode, e.g. the book icon and text “Text Mode”, will be shown and overlap the real-time picture on the screen 42. As the same method in the first embodiment, when the button 44 is pressed during the waiting time, e.g. 3 seconds, the next display mode will be shown on the screen 42, e.g. “Movie Mode”. Similarly, the real-time picture on the screen 42 is displayed according to the display parameters of that display mode. When the button 44 is not pressed during the preset waiting time, e.g. 3 seconds, the display device 40 is designed to select that display mode and to terminate the display of the icon and the illustration text 46 on the screen 42. When the button 44 is pressed once again during the preset waiting time, e.g. 3 seconds, the next display mode will be shown on the screen 42. While the last mode is shown on the screen 42, and the button 44 is pressed once again, then the first display mode will be shown on the screen 42.

The other detailed procedures of the adjustment method for the display performance are the same as those in the first embodiment, and will not be repeated here. The button 44 in this embodiment can be located on a remote controller instead of the display device 40 according to the spirit of the present invention. The user can use the button 44 on the remote controller to quickly and conveniently select the suitable display mode according the practical usage situation without doing the complicated setting of the profound display parameters, and has a great benefit of the easy, friendly and convenient operations.

The display device in this embodiment can be a TV, a digital photo frame, a cell phone, an image player or other devices with the similar display functions. Furthermore, the portfolio of the display modes can be determined based on the product types of the display devices. As to the variety of the display modes, several examples cited in the second embodiment can be consulted for the reference. For instance, if the display device is a digital photo frame, the scenery mode, portrait mode, vivid mode, etc. can be suitably introduced as the available choices for the users.

In conclusion, the present invention provides a display device and the adjustment method therefor. The easy, friendly and convenient operations are designed in the present invention with the technical novelty and the aspect from human beings. The complicated setting procedures for the display parameters with the profound and professional terms in the current techniques can be obviated. Therefore, the present invention can provide great benefits to all the users.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An adjusting method for a display device, wherein the display device includes a screen, a button and plural display modes including at least a first display mode and a second display mode, the method comprising steps of:
pressing the button once to display the first display mode on the screen when the display device is on;
waiting for a waiting time when the first mode is desired to be selected;
pressing the button again during the waiting time to display the second display mode on the screen when the first mode is not desired to be selected; and
waiting for the waiting time when the second mode is desired to be selected.

2. A method of claim 1, further comprising a step of:
when the second mode is not desired to be selected, pressing the button again during the waiting time to display the first display mode if the plural display modes have only two display modes, and to display a next display mode if the plural display modes have more than two display modes.

3. A method of claim 1, wherein each of the plural display modes is one selected from a group consisting of a general mode, a text mode, a game mode, a movie mode, an X-contrast mode, an X-fine-tuning mode, an internet mode, a portrait mode, a scenery mode, a vivid mode, a sports mode and a diagram mode, and the plural display modes are different from one another.

4. A method of claim 1, wherein the waiting time is in a range of 2 to 5 seconds.

5. A method of claim 1, further comprising a step of pressing the button once to turn on the display device when the display device is off.

6. A method of claim 1, further comprising a step of pressing the button for a holding time to turn off the display device when the display device is on.

7. A method of claim 6, wherein the holding time is in a range of 2 to 5 seconds.

8. A method of claim 1, wherein each of the plural display modes comprises predetermined display parameters, each of which is one selected from a group consisting of a brightness, a contrast ratio, a color temperature, a gamma value and a sharpness, and the predetermined display parameters are different from one another.

9. A display device having plural display modes, comprising:
a button selecting a first display mode from the plural display modes, wherein the first display mode is selected by using only the button; and
a screen displaying the first display mode.

10. A display device of claim 9, wherein the display device is a flat panel display device.

11. A display device of claim 10, wherein the flat panel display device is one selected from a group consisting of a liquid crystal display device, a plasma display device, a light emitting diode display device, an organic light emitting diode display device and a carbon nano-tube display device.

12. A display device of claim 9, wherein the display device is used as one selected from a group consisting of a television, a monitor, a digital photo frame, a mobile phone and an image player.

13. A display device of claim 9, wherein each of the plural display modes is one selected from a group consisting of a general mode, a text mode, a game mode, a movie mode, an X-contrast mode, an X-fine-tuning mode, an internet mode, a portrait mode, a scenery mode, a vivid mode, a sports mode and a diagram mode, and the plural display modes are different from one another.

14. A display device of claim 9, wherein the button is used to turn on and to turn off the display device.

15. A display device of claim 14, wherein the button is pressed once to turn on the display device when the display device is off.

16. A display device of claim 14, wherein the button is pressed for a holding time to turn off the display device when the display device is on.

17. A display device of claim 16, the holding time is in a range of 2 to 5 seconds.

18. A display device of claim 9, wherein:
the plural display modes comprise at least the first display mode and a second display mode; and
one of the plural display modes is selected and displayed on the screen by steps comprising:
pressing the button to display the first display mode on the screen when the display device is on;
waiting a waiting time when the first display mode is desired to be selected;
pressing the button again during the waiting time to display the second display mode on the screen when the first mode is not desired to be selected;
waiting for the waiting time when the second mode is desired to be selected; and
when the second mode is not desired to be selected, pressing the button again during the waiting time to display the first display mode if the plural display modes have only two display modes, and to display a next display mode if the plural display modes have more than two display modes.

19. A display device of claim 18, wherein the waiting time is in a range of 2 to 5 seconds.

20. A display device of claim 9, wherein each of the display modes comprises predetermined display parameters, each of which is one selected from a group consisting of a brightness, a contrast ratio, a color temperature, a gamma value and a sharpness, and the predetermined display parameters are different from one another.
